(19) United States
(12) Patent Application Publication
(10) Pub. No.: US 2006/0170689 A1
(43) Pub. Date: Aug. 3, 2006

(54) Image display system

(76) Inventors: Michael Maier, VS-Schwenningen (DE); Thomas Sagcob, Donaueschingen (DE); Bernhard Broghammer, Tennenbronn (DE)

Correspondence Address: BRINKS HOFER GILSON & LIONE, P.O. BOX 10395, CHICAGO, IL, 60610, US

(21) Appl. No.: 11/182,526

(22) Filed: Jul. 15, 2005

Related U.S. Application Data
(63) Continuation-in-part of application No. PCT/EP04/00208, filed on Jan. 14, 2004.

(51) Int. Cl. G09G 5/00; G06T 1/00

(52) U.S. Cl. 345/501; 345/156; 345/629

(57) ABSTRACT

An image display system delivers image data to multiple separate displays without expensive duplication of image processing hardware. The image display system may be used in a vehicle to distribute many types of information to different individuals in the vehicle. The image display system may deliver navigational information to a driver, while providing movies, video game, or other entertainment images to other passengers.

### PRIORITY CLAIM

This application is a Continuation-in-Part of International Application No. PCT/EP2004/000208, filed Jan. 14, 2004 and published in English as International Publication No. WO 2004/066139 A1. This application incorporates by reference International Application No. PCT/EP2004/000208 in its entirety.

### BACKGROUND OF THE INVENTION

1. Technical Field

The invention relates to image display systems. In particular, this invention relates to an image display system which supplies image data to multiple displays in a vehicle.

2. Related Art

Today, vehicles commonly include information and entertainment devices which generate and present image displays to the driver and passengers. Each display generally operates independently of any other display. For instance, the vehicle may provide a navigational display for the driver and entertainment displays for the other passengers. Since the driver needs to focus on the surrounding traffic, the driver display concentrates on providing important information such as directional information. The passenger displays may present a wider range of information, such as detailed maps, travel information, or supplemental navigation information. The passenger displays may also display video programming or other visual information generated by a television or radio receiver, a DVD player, a cell phone, an Internet access device, vehicle control devices, a vehicle rearview device or other devices.

The images for each separate display are generated separately using independent image display systems. The image display systems may include a graphics processor which generates the image display signals which drive the displays. A CPU controls the operation of the graphics processor by supplying image generation commands and image data to the graphics processor.

One problem with prior display systems was that each display was controlled by separate image processing hardware. A separate CPU provided display content and a separate graphics processor generated a display image signal. Hardware duplication increased the cost and complexity of the display systems, generated additional heat which had to be dissipated, required extra space on circuit boards and for housings, and required additional costly electromagnetic compliance (EMC) shielding.

In other implementations, one set of image processing hardware provided image information for multiple displays. However, in some cases the prior display systems required the displays to include additional hardware and processing complexity to correctly display the images. In other implementations, the display systems had only limited capability to deliver image data to each display. Therefore, a need exists for an image display system that addresses the problems noted above and previously experienced.

### SUMMARY

This invention provides an image display system. The display system flexibly generates images on multiple displays in a vehicle or other environments. The display system may be incorporated into a vehicle to deliver both information and entertainment to multiple displays in the vehicle. For example, the display system may provide navigational information to the driver, while providing detailed map and surrounding attraction audio and video to the passengers.

The image display system processes an image display input signal according to partitioning parameters. The input signal includes image data which will be divided and delivered to multiple displays. The image display system partitions the combined image data according to the partitioning parameters. Multiple image display signals drive the partitioned image data to different displays.

The partitions may be spatial or temporal partitions. Spatially partitioned image data may be subsequently temporally partitioned and temporally partitioned data may be subsequently spatially partitioned. The combined image data may be a sequence of image frames and may interleave image content from multiple different input sources. The input sources may include navigational systems, video (e.g., DVD) players, video games, television broadcasts, and other sources.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates an image display system.

FIG. 2 illustrates an image display system.

FIG. 3 illustrates an image display system including a man-machine-interface.

FIG. 4 illustrates an image display input signal containing image information from two different image display signal sources.

FIG. 5 illustrates two image display signals generated from an image display input signal.

FIG. 6 illustrates an image display input signal containing image information from two different image display signal sources.

FIG. 7 illustrates two image display signals generated from an image display input signal.

FIG. 8 illustrates an image display input signal divided into two equal vertical spatial partitions.

FIG. 9 illustrates an image display input signal divided into two unequal vertical spatial partitions.

FIG. 10 illustrates an image display input signal divided into two equal horizontal spatial partitions.

FIG. 11 illustrates an image display input signal divided into two unequal horizontal spatial partitions.

FIG. 12 illustrates an image display input signal divided into two horizontal and two vertical spatial partitions.

FIG. 13 illustrates an image display input signal divided into three partitions.

FIG. 14 illustrates a memory system which may be part of an image display generator.

FIG. 15 illustrates a memory system which may be part of an image display generator.

FIG. 16 illustrates partitioning a display into two spatial partitions.

FIG. 17 illustrates acts which may be taken for temporally partitioning image data for display on separate displays.

FIG. 18 illustrates acts which may be taken for spatially partitioning image data for display on separate displays.

FIG. 19 illustrates temporal partitioning to generate four image display signals.

FIG. 20 illustrates temporal and spatial partitioning to generate five image display signals.

### DETAILED DESCRIPTION OF THE PREFERRED EMBODIMENTS

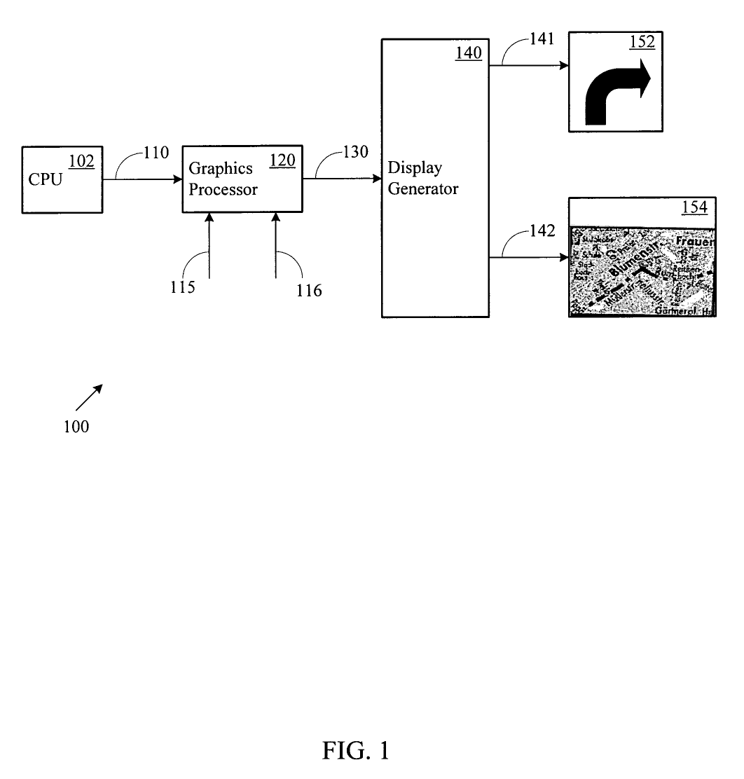

FIG. 1 shows an image display system 100. A CPU 102 generates image content and control information 110 and provides the image content and control information 110 to the graphics processor 120. The graphics processor 120 generates an image display signal 130 based on the received image content and control information 110. The image content and control information 110 may convey image information obtained from one or more sources, including interleaved video frames obtained from the sources.

The image display input signal 130 may include image display information for multiple independent displays. The image display input signal 130 may convey navigational information such as map data, Global Positioning System (GPS) data, topological overlay data, travel and trip planning information, or other data. The image display input signal 130 may also convey audiovisual information generated by entertainment devices in the vehicle, received from road and weather condition information sources, or obtained from any other information source.

FIG. 1 shows image content information 115 and 116 which external sources provide to the graphics processor 120 on source inputs The graphics processor 120 generates the image display output signal 130 as a combination of audiovisual content from multiple sources for distribution to multiple displays. Examples of external sources include CDs, DVDs, hard disks, solid state memory, and other forms of volatile or non-volatile memory. Other external sources include wired or wireless receivers for WiFi, Bluetooth, radio, and television signals. The image display output signal 130 may include a combination of any of the received image content information 110, 115, or 116 for delivery to any number of displays such as the display 152 and the display 154.

A display may be mounted in view of the driver such as on the dashboard or formed from projected images as a heads-up display on the windshield. One or more displays may also be mounted in the ceiling, in seats, or in other locations in view of vehicle passengers. The displays 152 and 154 may vary widely in resolution, for example 32-2048 pixels wide and 32-2048 pixels high, or other resolutions. In one implementation the display 152 has a 480×200 pixel resolution and the display 154 has an 800×480 pixel resolution.

The displays 152 and 154 may be provided independently of the image display system 100. The displays 152 and 154 may be located anywhere in the vehicle and may be connected wirelessly or through signal cables to the image display system 100. For use with a vehicle multimedia system, wireless transmission and reception facilitates the placement of the displays within the vehicle compartment. Wireless transmission may be implemented with a Bluetooth connection, WiFi connection, infrared connection, or other wireless connections.

The image display output signal 130 may be supplied to an image display generator 140 through a signal input. The image display generator 140 selectively partitions content from the image display output signal 130 to generate display signals for multiple displays. FIG. 1 shows an image display signal 141 which drives the display 152 and an image display signal 142 which drives the display 154. Thus, image content combined by the graphics processor 120 into the image display output signal 130 is extracted for delivery to multiple displays.

The image display system 100 leverages the processing capabilities provided by the graphics processor 120. The graphics processor 120 combines image content from multiple sources into the image display output signal 130. The display generator 140 may then partition the content in the image display output signal 130 to drive multiple displays. The image display system 100 avoids duplicating individual dedicated processing hardware for each image display signal to be generated. The image display system 100 may provide reduced cost and complexity, reduced heat generation, and improved space efficiency.

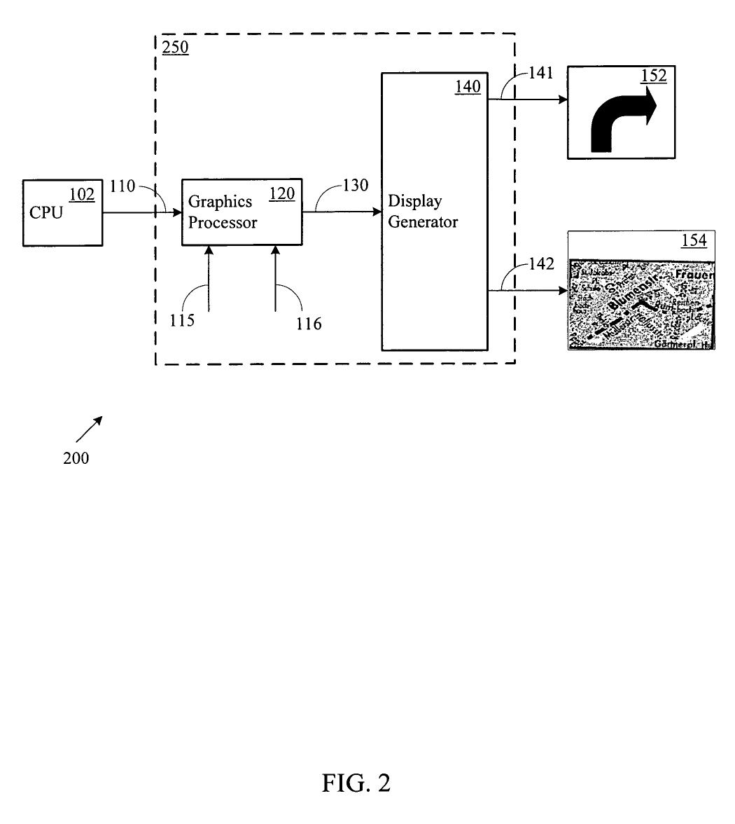

FIG. 2 shows an alternative image display system 200. In the display system 200, the display generator 140 and the graphics processor 120 integrate into a single graphics processor 250. The graphics processor 250 may be implemented on a single chip, for example. The graphics processor 250 includes input terminals for receiving the image content and control information 110, 115, and 116 and output terminals for driving multiple displays with image display signals.

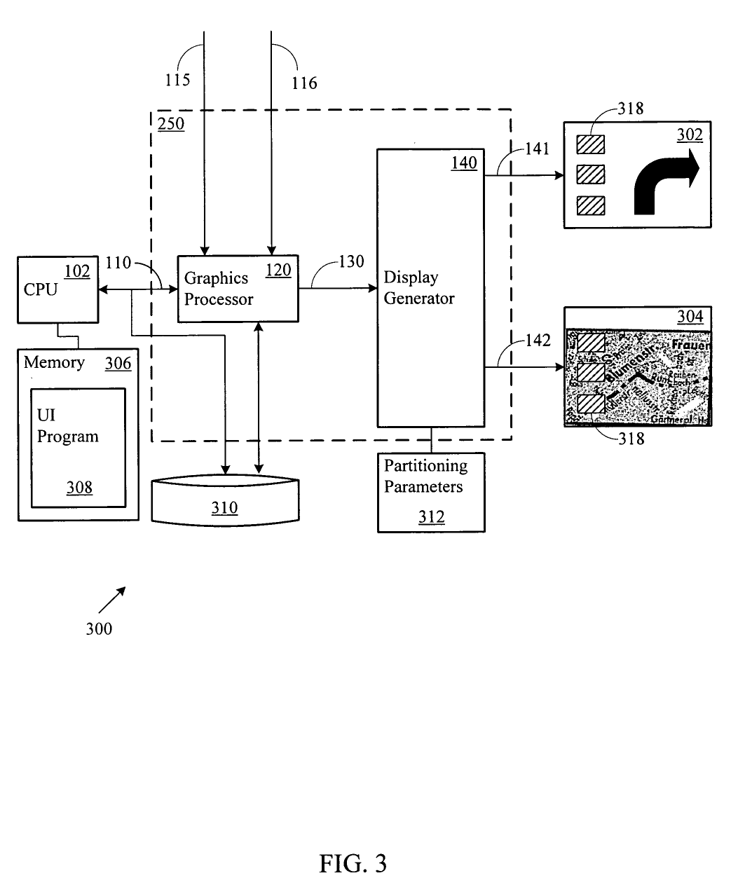

FIG. 3 shows an interactive image display system 300. The image display system 300 provides navigational information on the display 302 for the driver, and provides additional audiovisual information on the display 304 for the passengers. In addition, the CPU 102 is connected to a memory 306. The memory 306 stores a user interface program 308 for execution by the CPU 102.

The user interface program 308 generates a user interface on any of the displays connected to the system 300. To that end, the CPU 102 may issue image generation instructions to the graphics processor 120 for generating the user interface on the displays. The user interface may include soft-keys 318 responsive to operator touches on the displays 302 and 304. However, other user interface elements may be employed, including interactive drop down lists, text input boxes, or other elements.

An operator interacts with the soft-keys 318 to provide input to the system 300. The CPU 102 may respond to the soft-keys 318 to provide interactive features such as route selection, travel statistic and itinerary display selection, toggling on or off voice instructions, selecting voice parameters such as language, volume, tone, or other parameters, help topic selections, or other interactive features. Alternate or additional man-machine interfaces may be provided, such as mechanical buttons, voice recognition, keyboard or mouse input, or other operator interfaces which provide operator interactivity with the system 300.

The CPU 102 may generate the same or different user interfaces for each display. Each display may therefore include its own operator interactive interface elements appropriate for image content delivered to any display. The individual user interfaces and the displayed images may include image components provided in the database 310. For example, the database 310 may store navigational information such as map images, route selections and driving instructions, travel statistics and itinerary displays, help features, vehicle performance data, telephone and address directory information, or other audio or visual information.

FIG. 3 also shows partitioning parameters 312. The partitioning parameters establish operating variables for the display generator 140. The partitioning parameters 312 may include temporal operating parameters which govern temporal partitioning of the image display output signal 130, as well as spatial operating parameters which govern spatial partitioning of the image display output signal 130. The partitioning parameters 312 may be stored, read, or modified in or from a memory accessible by the display generator 140 and/or the CPU 102. The partitioning parameters 312 may dynamically change. Thus, the display system 100 may flexibly re-direct image content to any display by changing the partitioning parameters 312.

Spatial partitioning parameters may include horizontal and vertical partition sizes and positions, display resolution information, and other parameters which specify how image data will be spatially divided. Temporal partitioning parameters may include specifiers which establish which display will receive which frame. The frame specifiers may match frames, signal sources, time, or other parameters to displays. As examples, the frame specifiers may establish that a first display receives every fifth frame, a second display receives a frame every 10 ms, and that a third display receives frames generated by a video game or other input source.

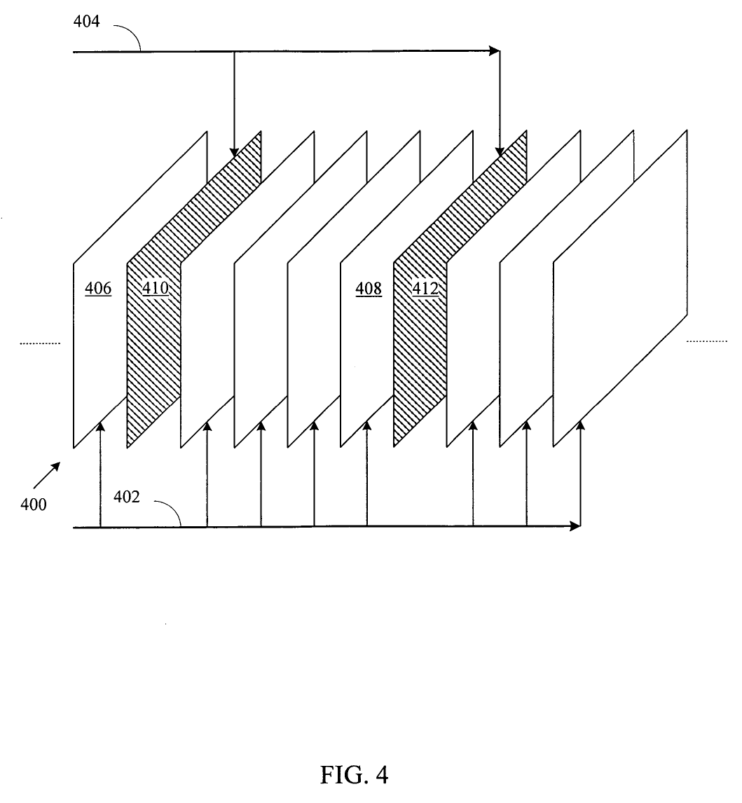

FIG. 4 illustrates an image signal 400 which combines image data from separate image input display signals 402 and 404. The input display signals 402 and 404 provide image data which may originate with different audiovisual sources (e.g., a navigation program display output and a DVD player output) or may represent image data provided by the CPU 102. The image data may be provided in the form of image frames. FIG. 4 shows image data 410 and 412 originating from the input display signal 404 and image data (a portion of which is labeled 406 and 408) which originate from the input display signal 402.

The CPU 102 may provide the image signal 400 to the graphics processor 120 for rendering as the image display output signal 130. Alternatively or additionally, the graphics processor 120 may add image data obtained from the external sources 115 and 116 to form the image signal 400. As one example, the image data 410 and 412 may include navigational information for the driver, while the image data 406 and 408 may include video programming from a DVD player. In addition, the CPU 102 may include user interface data in addition to any of the image data 406-412 in one or more temporal or spatial image partitions for rendering on any of the displays.

The amount of image data allocated for each of the displays may differ. For instance, video data for a movie to be delivered to a rear seat display may include a large amount of image data and may occupy a relatively large amount of the image data in the image signal 400. On the other hand, navigational images to be delivered to a dashboard display may include a relatively small amount of image data any may occupy a relative small amount of the image data in the image signal 400.

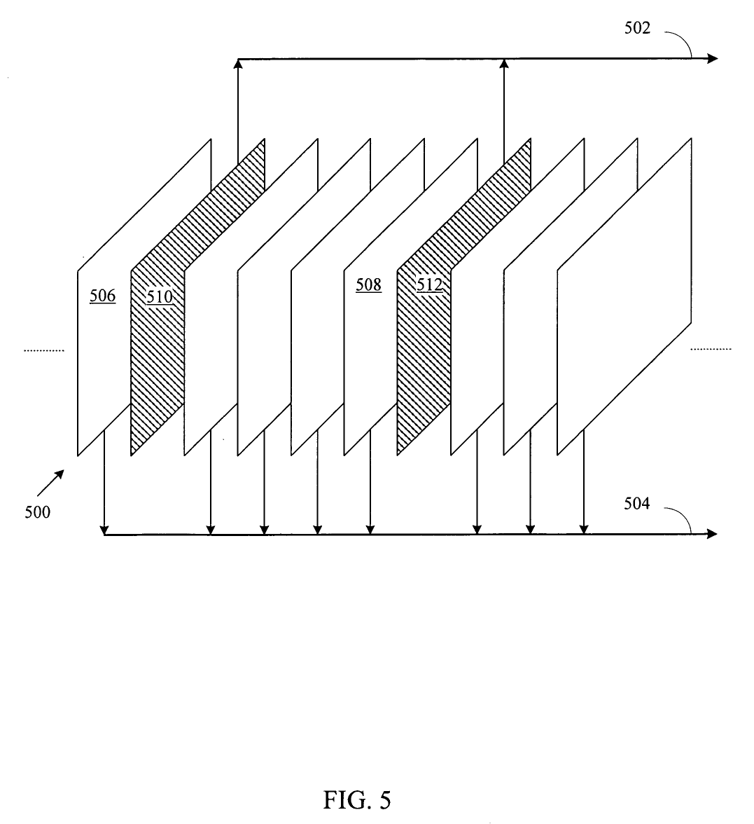

FIG. 5 illustrates a partitioning procedure executed by the image display generator 140 to temporally partition image data in the image display output signal 500. The image display generator 140 may select individual frames (e.g., the frames 506, 508, 510, and 512) for delivery to different displays (e.g., the displays 152 and 154) through the image display signals 502 and 504. For example, the image frames 510 and 512 may represent rendered navigation information to be delivered to the driver dashboard display through the display signal 502, while the image frames 506 and 508 may represent rendered video information to be delivered to the rear seat display through the display signal 504. The partitioning parameters 312 may specify which frames will be delivered to which displays (e.g., delivery every fifth frame to the driver dashboard display).

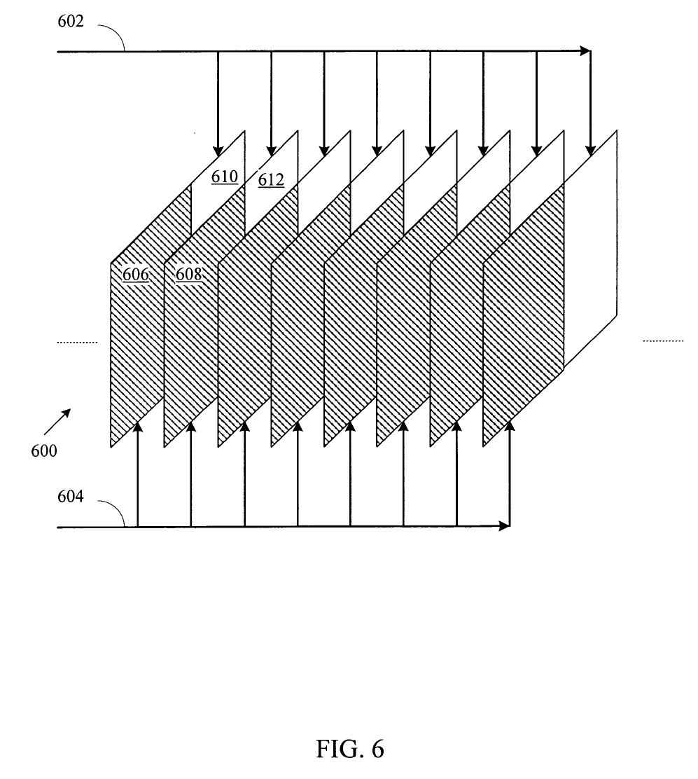

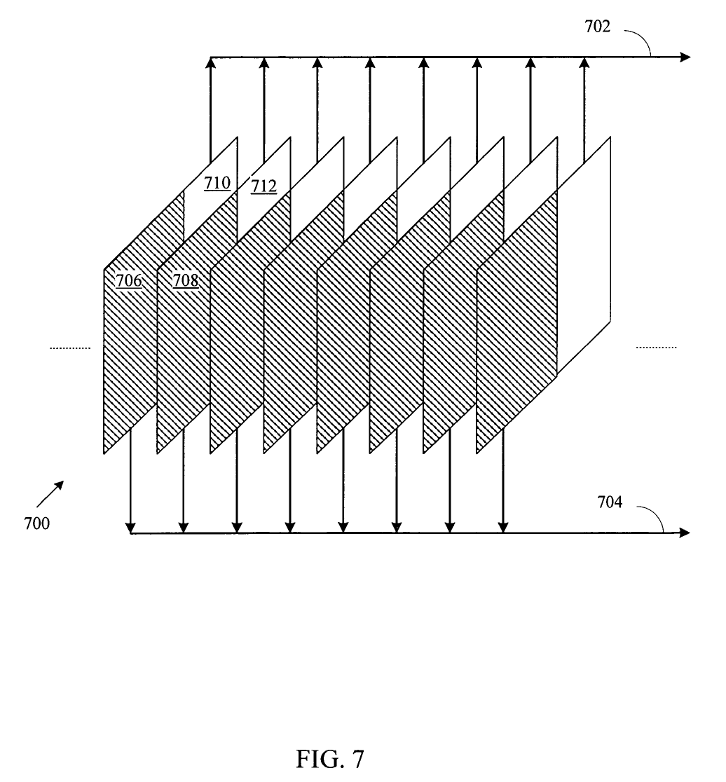

FIG. 6 and FIG. 7 illustrate spatial partitioning of image information. The image data obtained from separate input signals 602 and 604 is combined to form the image signal 600. The horizontal spatial partitions shown in FIG. 6 allocate a portion of each line in the combined image data for image information for each display. FIG. 6 shows image data 606 and 608 for a first display combined with image data 610 and 612 for a second display. The image data 606 and 608 occupies a first portion of each horizontal display line, while the image data 610 and 612 occupies a second portion of each horizontal display line. Any number of horizontal partitions may be employed.

The display generator 140 spatially partitions the image display output signal 700 to generate the display signal 702 and the display signal 704. The display generator 140 separates the image data of each line to obtain the image data for the individual displays. Accordingly, the image data 706 and 708 drives a first display, while the image data 710 and 712 drives a second display. The portion of each line allocated to each display may vary from image frame to image frame or from line to line and may be specified by the partitioning parameters 312.

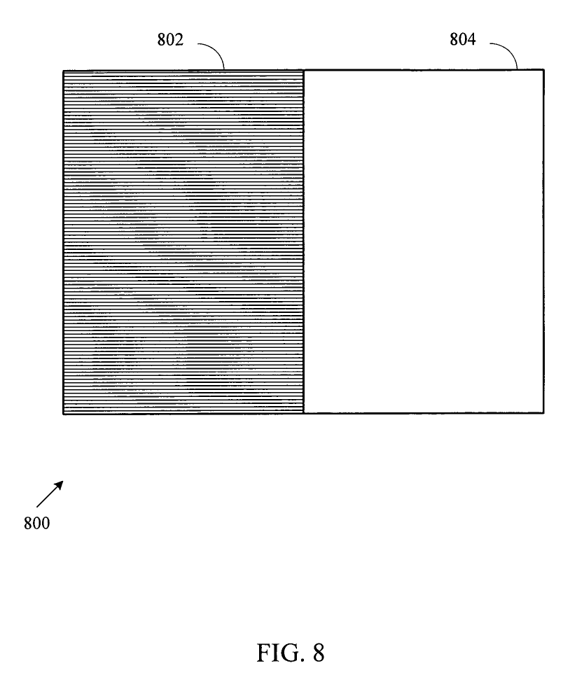

Examples of other spatial divisions of the individual images are illustrated in FIG. 8 to FIG. 13. FIG. 8 shows an image frame 800 which includes two horizontal partitions 802 and 804. Each horizontal partition 802 and 804 may carry image data for a different display.

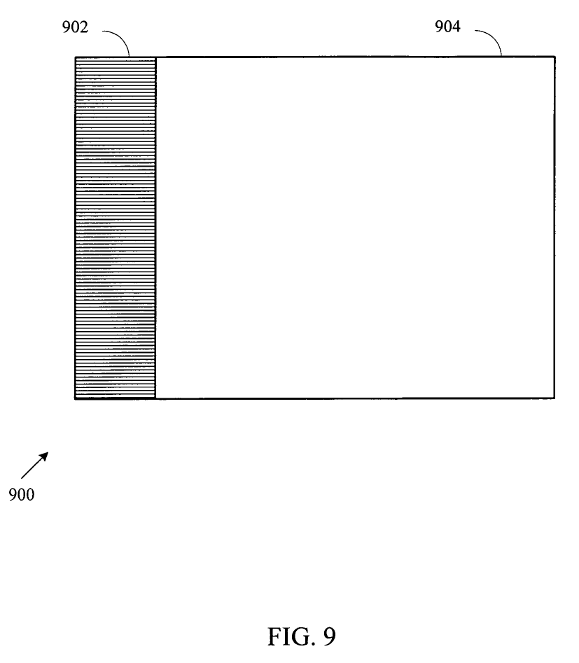

Each image frame may be divided into partitions of any size. The partitions may be chosen to meet the data expectations or resolution of any particular display or images to be shown on a display. FIG. 9 shows an image frame 900 divided into unequal partitions 902 and 904. The partition 904 provides additional image data over the amount provided in the partition 902.

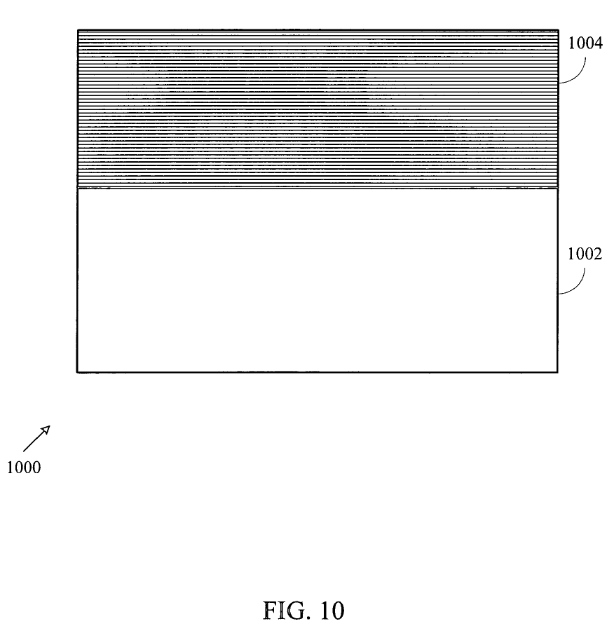

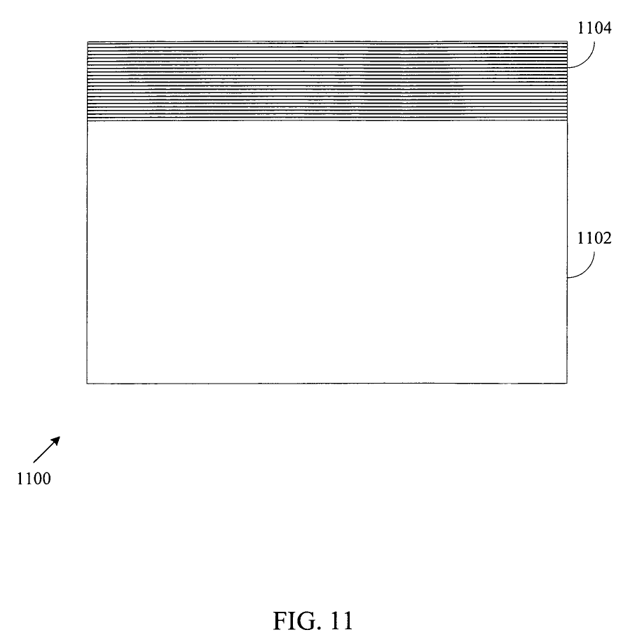

Image frames may be spatially partitioned in other ways. FIG. 10 shows an image frame 1000 in which the image lines are divided into two vertical partitions 1002 and 1004. Each partition 1002 and 1004 provides approximately the same amount of image data. FIG. 11 shows an image frame 1100 divided into two unequal vertical partitions 1102 and 1004. The partition 1004 may deliver relatively more image data to a display than the partition 1002. The sizes of each partition may vary between frames and may adapt to the resolution of data expectations of each display.

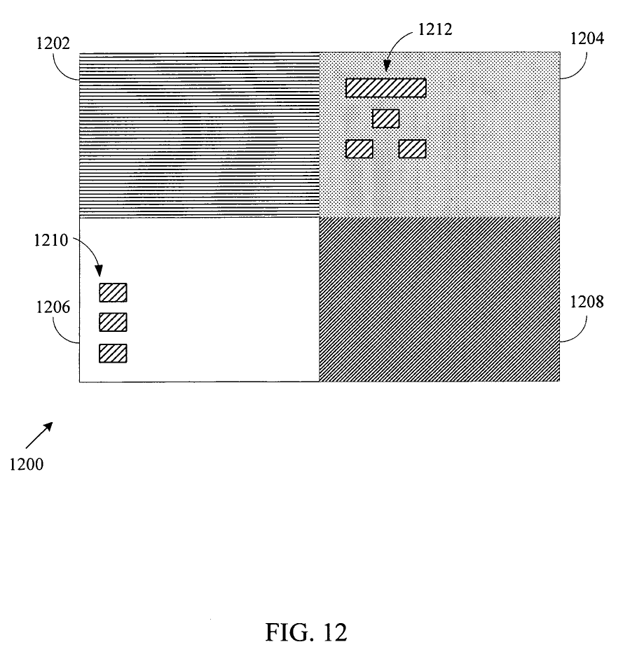

Image frames may be partitioned for more than two displays by dividing image lines both horizontally and vertically to form additional vertical or horizontal partitions. FIG. 12 shows an image frame 1200 divided into four partitions 1202, 1204, 1206, and 1208. Each partition 1202-1208 delivers approximately the same amount of image data to each of four displays.

The partition 1206 includes an operator interface 1210. The partition 1208 includes a different operator interface 1212. The CPU 102 instructs the graphics processor 120 to add image data which represents the operator interfaces 1210 and 1212. The graphics processor 120 overlays the user interface image data on portions of the combined image data in the image display output signal 130 corresponding to the partitions 1204 and 1206. Thus, the display which receives the image data in the partition 1204 also displays the operator interface 1212, while the display which receives the image data in the partition 1206 also displays the operator interface 1210.

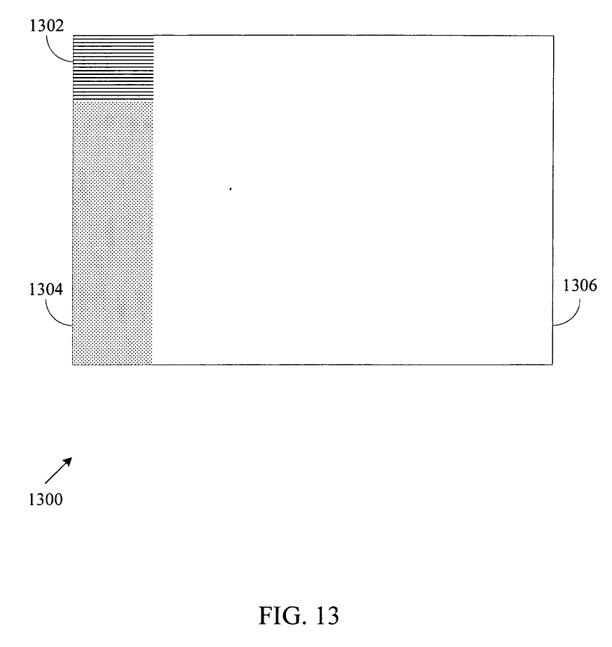

FIG. 13 shows an image frame divided into three unequal partitions 1302, 1304, and 1306. Each partition 1302-1306 may provide image data for a display with a different resolution. Alternatively, the display system 100 may use each partition to deliver data at a different rate to different displays.

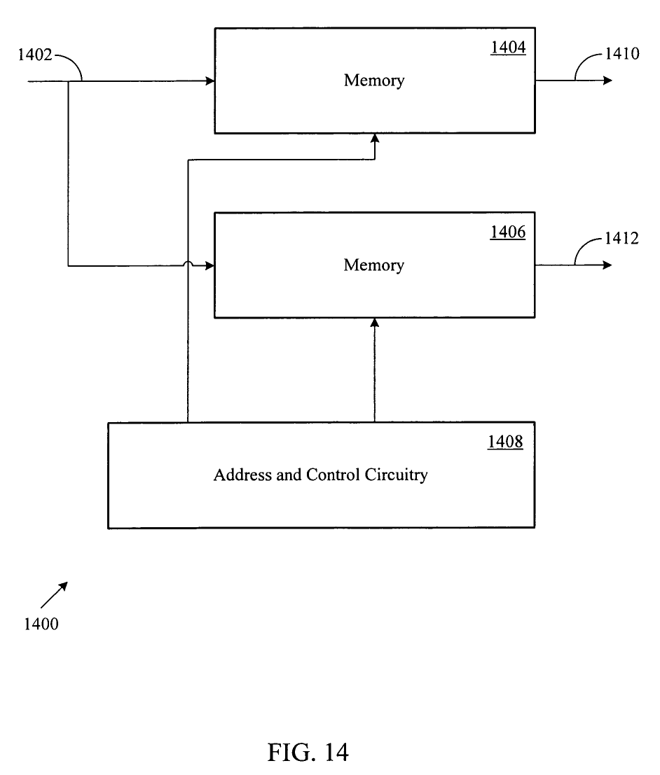

FIG. 14 illustrates a memory system 1400 which may be employed in the display signal generator 140. An image display input signal 1402 connects to the memories 1404 and 1406. Memory address and control circuitry 1408 controls writing input signal data into the memories 1404 and 1406 and retrieving data from the memories 1404 and 1406. The image data read from the memory 1404 provides the display signal 1410 and the data read from the memory 1406 provides the display signal 1412 for a second display. The address and control circuitry 1408 coordinates writing and reading image data to provide the display signals 1410 and 1412.

In FIG. 14, the address and control circuitry 1408 writes image data from the image display input signal 1402 into the memories 1404 and 1406 based on the partitioning of image data in the input signal 1402. The address and control circuitry 1402 generates write addresses for storing image data into the memories 1404 and 1406. The address and control circuitry 1408 may be implemented with a microprocessor, microcontroller, application specific integrated circuit, or other circuitry or logic.

The address and control circuitry 1408 may consecutively read image data from the memories 1404 and 1406 to provide the image display signals 1410 and 1412. For horizontal spatial partitions, the address and control circuitry 1408 may write image data from a portion of each line into each memory 1404 and 1406. The memories 1404 and 1406 may be FIFO line memories and may store the portions of each line (e.g., a 400 pixel portion and a 1200 pixel portion of a 1600 pixel line) to be provided to each independent display. Line memories may be provided for each partition of a line in an input image signal.

The image display generator 140 may allocate any of the frames in an input image signal to any number of displays according to preconfigured partitioning parameters 312. As examples, the partitioning parameters 312 may establish that the display generator 140 will drive every other frame, every third frame, or every fifth frame to one display, and the remaining frames to a different display. For temporal partitioning or spatial partitioning, the display signal generator 140 may include one or more memories which store all or part of one or more image frames.

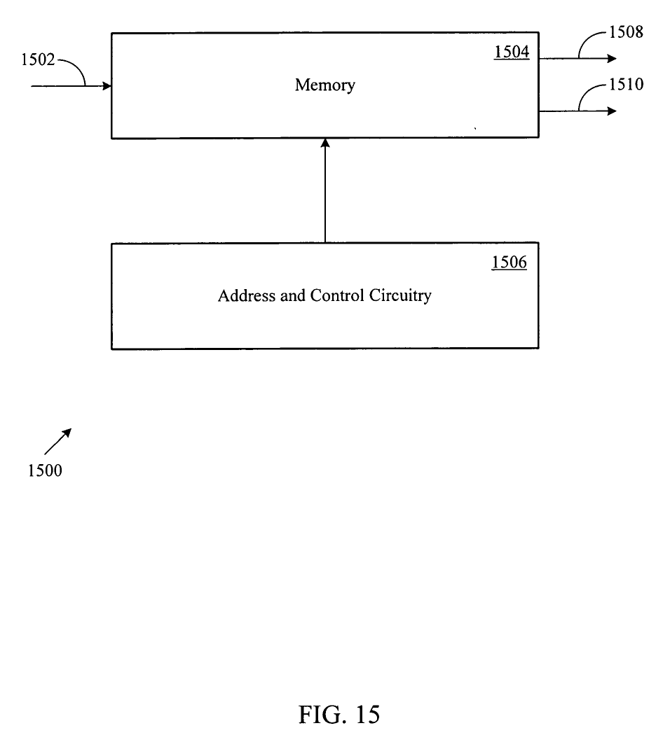

FIG. 15 shows a memory system 1500 which may be employed in the display signal generator 140. An image display input signal 1502 connects to the memory 1504. Memory address and control circuitry 1506 controls writing input signal data into the memory 1504 and retrieving image data from the memory 1504. The image data read from the memory 1504 provides one or more display signals, such as the display signals 1508 and 1510. The address and control circuitry 1506 coordinates writing and reading image data to provide the display signals 1508 and 1510.

The memory 1504 may be a frame memory which stores one or more frames of image data. The address and control circuitry 1506 retrieves image data from the memory 1504 to generate multiple image display signals. FIG. 15 shows that the address and control circuitry 1506 generates an image display signal 1508 for a first display and an image display signal 1510 for a second display. For example, the address and control circuitry 1506 may retrieve the first ‘n’ lines of an image frame for delivery in the display signal 1508 and the remaining ‘m’ lines of the image frame for delivery in the display signal 1510.

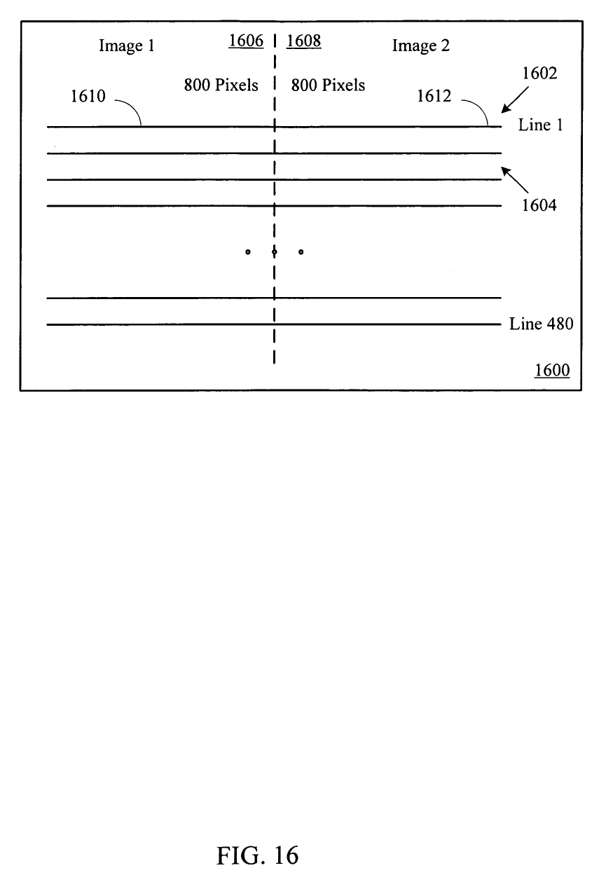

FIG. 16 provides an additional example of a partitioned image frame 1600. The image frame 1600 includes multiple horizontal lines each 1600 pixels long. The first two horizontal lines are labeled 1602 and 1604.

The image display generator 140 may spatially partition the image frame 1600 in many different ways. FIG. 16 shows two horizontal spatial partitions 1606 and 1608 for the image frame 1600. The image data in the spatial partition 1606 provides the image data for a first display, while the image data in the spatial partition 1608 provides the image data for a second display. In the example shown in FIG. 16, each vertical spatial partition spans 800 pixels.

The image display generator 140 may divide the image frame 1600 into the partitions 1606 and 1608 using the memories 1404 and 1406. The image display generator 140 may store the first 800 pixels of each line (e.g., the first 800 pixels 1610 of the first line 1602) in the memory 1404. The second 800 pixels of each line (e.g., the second 800 pixels 1612 of the second line 1604) may be stored in the second memory 1406.

The image display generator 140 reads the memories 1404 and 1406. The image display signals 1410 and 1410 provide the image data obtained from the memories 1404 and 1406. Each image display signal 1410 and 1412 drives a different display, such as the displays 152 and 154.

The division of the display 1600 may occur on a line-by-line basis. The memories 1404 and 1406 may therefore be small and inexpensive memories which store a portion of each line which will be driven to the independent displays 152 and 154. Alternatively, the image display generator 140 may store image data from the frame 1600 in the frame memory 1504. The address and control circuitry 1506 may then read the image data from each partition 1606 and 1608 from the memory 1504 and drive the image data on the display signal outputs 1508 and 1510.

The image display signals may deliver widely varying image content to multiple displays. For vehicle navigation, one display image signal may deliver directional commands generated by the car navigation system to the driver. A second display image signal may deliver detailed map data for regional maps, topographical overlays, audiovisual programming, travel and tourism information, or other information to a passenger display. Other image signals may deliver other types of video, such as motion pictures, video games, or computer application displays. Thus, the amount of information provided to any display may differ significantly from the information provided to other displays.

The vehicle may incorporate the image display system 100 into a vehicle information and entertainment system. The vehicle information and entertainment system may receive image data from multiple sources and distribute image signals to multiple displays in the vehicle. The sources may include a car navigation system, a television receiver, a DVD player, a cell phone, video game, a wireless phone, an Internet access device, a vehicle control device, a rearview device, or other sources.

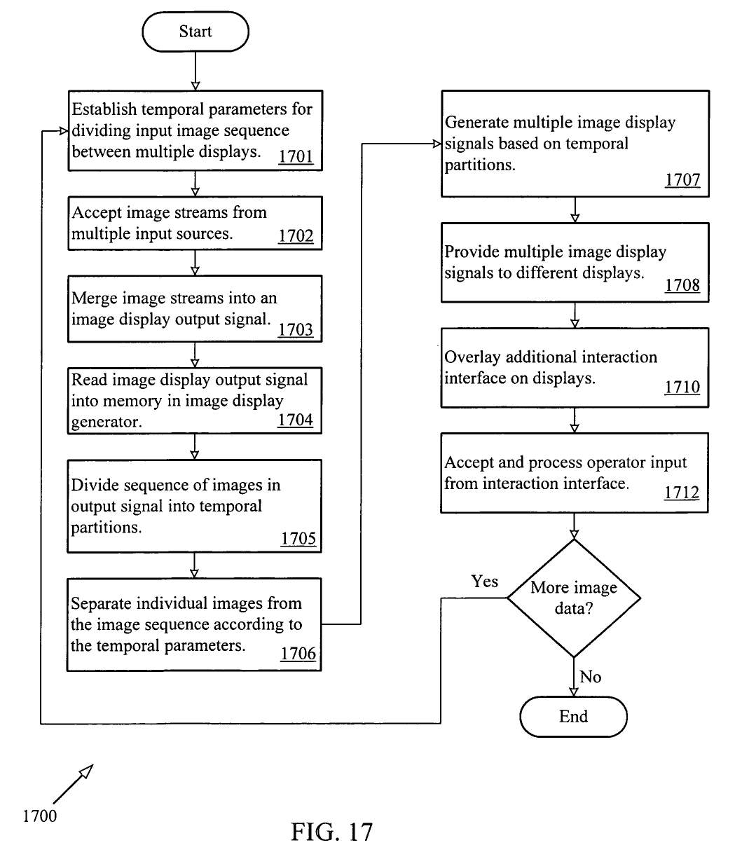

FIG. 17 illustrates acts 1700 which the display generator 140 may take to generate multiple image display signals based on a temporal partitioning of the sequence of images contained in the image display input signal. Temporal partitioning parameters may be established for dividing the input image sequences between multiple displays (Act 1701). The image display system accepts input image streams from multiple input sources (Act 1702). The CPU 102 or graphics processor 120 merges the image streams into an input content signal 110 and provides an image display output signal 130 which includes image content from the multiple sources (Act 1703). The image display generator 140 reads the image display output signal 130 into memory (Act 1704).

The image display generator 140 divides the sequence of images in the image display output signal 130 into temporal partitions (e.g., by writing image data into memory), based on the temporal parameters 312 established for the input image sequence (Act 1705). The image display generator 140 separates individual images from the image data (Act 1706) (e.g., by reading partitions of image data from memory) and generates multiple image display signals based on the temporal partitions (Act 1707) and provides the display signals to different displays (Act 1708). In addition, the CPU 102 or graphics controller 120 may overlay an operator interface on any of the multiple displays (Act 1710). The CPU 102 may accept and process operator input (Act 1712) and provide responsive image information to any display (e.g., directional information or other navigational information).

The display generator 140 may spatially partition an image frame or portion of an image frame. Spatial partitioning may be performed independently of temporal partitioning or may proceed or follow temporally partitioning. Thus, an image frame temporally partitioned from an image display output signal may then be spatially partitioned.

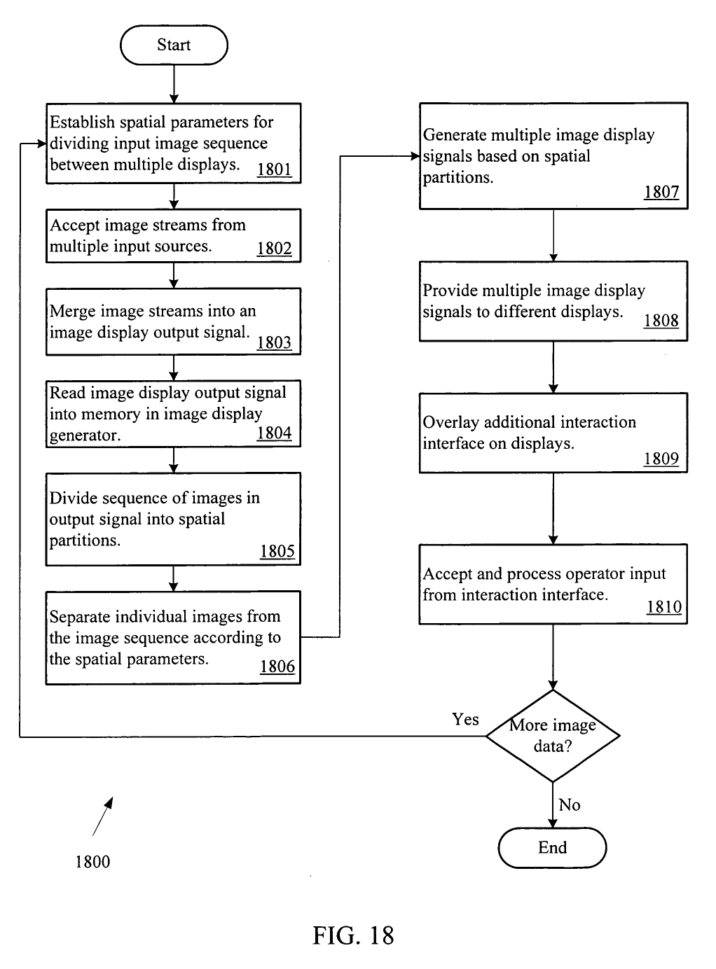

FIG. 18 illustrates acts 1800 which the display generator 140 may take to spatially partition image data into multiple image display signals. Spatial partitioning parameters may be established for dividing the input image sequences between multiple displays (Act 1801). The image display system accepts input image streams from multiple input sources (Act 1802). The CPU 102 or graphics processor 120 merges the image streams into an input content signal 110 and provides an image display output signal 130 which includes image content from the multiple sources (Act 1803). The image display generator 140 reads the image display output signal 130 into memory such as a line memory (Act 1804).

The image display generator 140 divides the image data in the image display output signal 130 into spatial partitions, based on the spatial parameters 312 established for the input image sequence (Act 1805). The image display generator 140 separates individual images from the image data (Act 1806) and generates multiple image display signals based on the temporal partitions (Act 1807) and provides the display signals to different displays (Act 1808). In addition, the CPU 102 or graphics controller 120 may overlay an operator interface on any of the multiple displays (Act 1809). The CPU 102 may accept and process operator input (Act 1810) and provide responsive image information to any display (e.g., the CPU 102 may begin playing a movie on a display).

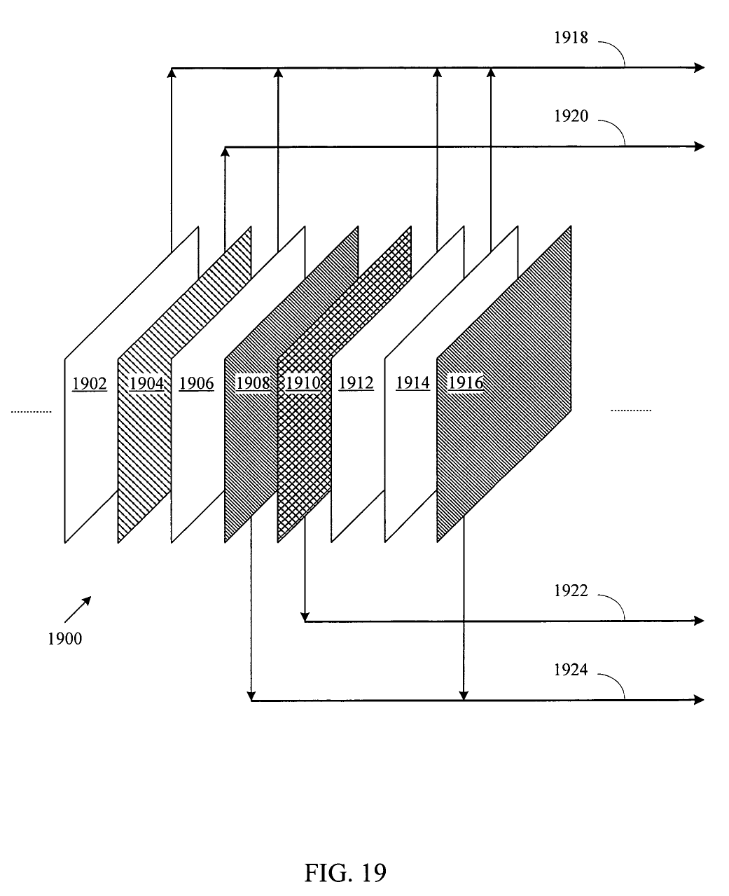

FIG. 19 illustrates temporally dividing a display signal 1900 which includes multiple image frames 1902, 1904, 1906, 1908, 1910, 1912, 1914, and 1916. The image frames 1902, 1906, 1912, and 1914 represent image frames for a first video stream (e.g., a movie). The image frame 1904 represents an image frame for a second video stream (e.g., a navigational application). The image frames 1908 and 1916 represent image frames for a third video stream (e.g., a video game). The image frame 1910 represents an image frame for a fourth video stream (e.g., an instant messaging display). The image display generator 140 partitions the display signal 1900 into multiple temporal partitions. Each temporal partition provides an image display signal for a different display.

FIG. 19 shows an example in which the image display generator 140 establishes four temporal partitions corresponding to the timing of specific types of image frames in the display signal 1900. Thus, the image display system provides four image display signals 1918, 1920, 1922, and 1924. The image display generator 140 delivers frames 1902, 1906, 1912, and 1914 as they temporally occur in the display signal 1900 to the first display in the image display signal 1918. The frame 1904 is delivered to the second display in the image display signal 1920. The image display generator 140 delivers frames 1908 and 1916 as they temporally occur to the fourth display in the image display signal 1924 and delivers frame 1910 to the third display in the image display signal 1922.

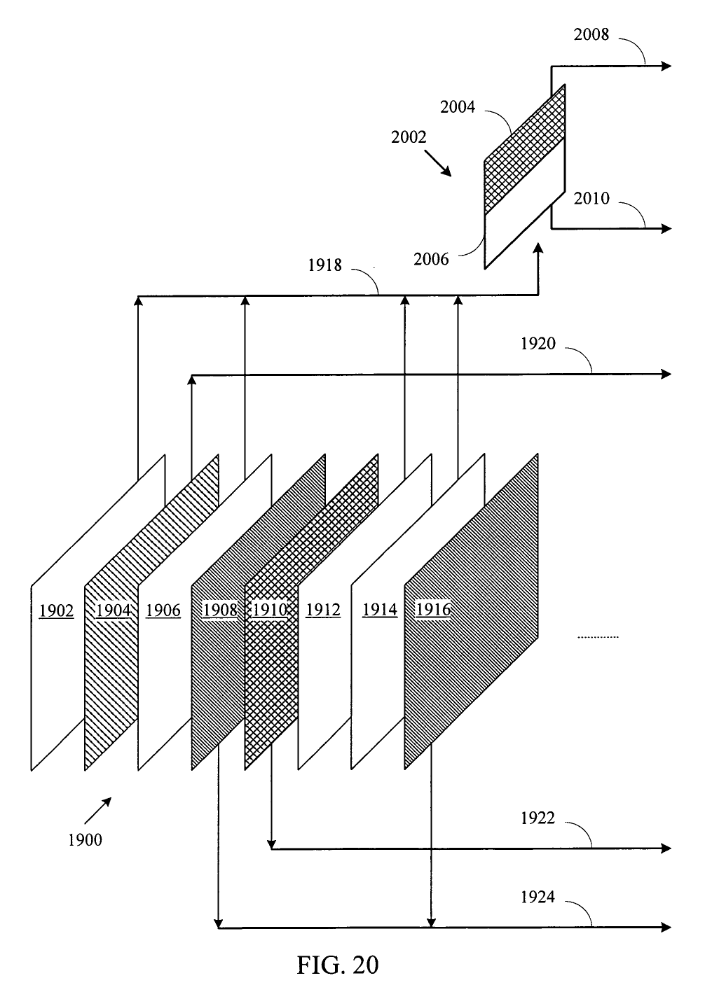

Temporal partitioning and spatial partitioning may complement one another. FIG. 20 shows an example of spatial partitioning following temporal partitioning. The display signal 1918 carries frames which were first temporally partitioned from the input display signal 1900. The image display generator 140 additionally applies a spatial partition to one or more of the frames in the display signal 1918.

FIG. 20 shows a temporally partitioned frame 2002 further partitioned into the vertical spatial partition 2004 and the vertical spatial partition 2006. Other types of spatial partitions may be employed, including horizontal partitions or combinations of horizontal and vertical partitions. Each vertical partition 2004 and 2006 may drive a different display through separate image display signals 2008 and 2010.

The image display generator 140 may be implemented in hardware and/or software. The image display generator 140 may include a digital signal processor (DSP), microcontroller, or other processor. The processor may execute instructions that read partitioning parameters, temporally and/or spatially partition image data, and generate multiple image display signals. Alternatively, the image display generator 140 may include discrete logic or circuitry, a mix of discrete logic and a processor, or may be distributed over multiple processors or programs.

The image display generator 140 may take the form of instructions stored on a machine readable medium such as a disk, EPROM, flash card, or other memory. The image display generator 140 may be incorporated into vehicles, office and home environments, or other locations where multiple displays are provided. The image display generator 140 drives multiple independent displays without substantial duplication of image processing hardware.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for displaying images, the method comprising:
obtaining an image display input signal comprising combined image data for multiple displays;
reading a partitioning parameter;
partitioning the combined image data into first image data and second image data according to the partitioning parameter; and
generating multiple image display signals from the first image data and second image data.

2. The method of claim 1, where obtaining comprises:
obtaining an image display input signal comprising image frames and where partitioning comprises:
temporally partitioning the image frames into the first image data and the second image data.

3. The method of claim 2, further comprising:
spatially partitioning the first image data into third image data and fourth image data; and where generating comprises:
generating a first image display signal from the first image data;
generating a second image display signal from the second image data;
generating a third image display signal from the third image data; and
providing the image display signals to at least three different displays.

4. The method of claim 1, where partitioning comprises:
horizontally partitioning the combined image data into the first image and the second image.

5. The method of claim 1, where partitioning comprises:
vertically partitioning the combined image data into the first image and the second image.

6. The method of claim 1, where the first image data comprises navigational data.

7. The method of claim 1, further comprising:
generating an operator interface;
adding the operator interface to a portion of the combined image data for display on at least one of the multiple displays.

8. An image display system comprising:
a signal input for receiving combined image data for multiple displays;
a memory comprising a partitioning parameter;
an image display generator coupled to the signal input and the memory, the image display generator operable to read the partitioning parameter and partition the combined image data into first image data and second image data according to the partitioning parameter and generate multiple image display signals from the first image data and second image data.

9. The system of claim 8, further comprising:
a graphics processor coupled to the signal input which generates the combined image data.

10. The system of claim 9, further comprising:
multiple source inputs which receive source image data from different input sources.

11. The system of claim 8, where the partitioning parameter comprises a spatial partitioning parameter.

12. The system of claim 8, where the partitioning parameter comprises a temporal parameter.

13. The system of claim 11, where the spatial parameters specify both horizontal and vertical partitions in the combined image data.

14. The system of claim 8, where the combined image data comprises an operator interface for display on at least one of the multiple displays.

15. A product comprising:
a machine readable medium; and
instructions stored on the medium for execution by an image display system which cause the image display system to perform a method comprising:
obtaining an image display input signal comprising combined image data for multiple displays;
reading a partitioning parameter;
partitioning the combined image data into first image data and second image data according to the partitioning parameter; and
generating multiple image display signals from the first image data and second image data.

16. The product of claim 15, where obtaining comprises:
obtaining an image display input signal comprising image frames and where partitioning comprises:
temporally partitioning the image frames into the first image data and the second image data.

17. The product of claim 16, further comprising:
spatially partitioning the first image data into third image data and fourth image data; and where generating comprises:
generating a first image display signal from the first image data;
generating a second image display signal from the second image data;
generating a third image display signal from the third image data; and
providing the image display signals to at least three different displays.

18. The product of claim 15, where partitioning comprises:
horizontally partitioning the combined image data into the first image and the second image.

19. The product of claim 15, where partitioning comprises:
vertically partitioning the combined image data into the first image and the second image.

20. The product of claim 15, further comprising:
adding an operator interface to a portion of the combined image data for display on at least one of the multiple displays.

21. A method of displaying images, comprising:
accepting source image data from multiple input sources;
merging the source image data into combined image data in an input image display signal;
defining a partition in the combined image data;
adding an operator interface into the partition in the combined image data;
dividing the combined image data into first partition image data comprising the operator interface and second partition image data;
generating a first display signal representing the first partition image data; and
generating a second display signal representing the second partition image data.

22. The method of claim 21, where the first partition image data is horizontal or vertical partition image data.

23. The method of claim 21, where dividing comprises:
temporally dividing the combined image data.

24. The method of claim 21, where dividing comprises:
temporally dividing the combined image data into the first partition image data and the second partition image data; and
spatially dividing the second partition image data.

25. The method of claim 21 further comprising dynamically redefining the partition.
